(19) United States
(12) Patent Application Publication
(10) Pub. No.: US 2021/0102645 A1
(43) Pub. Date: Apr. 8, 2021

(54) ASSEMBLY OF CABLE TRAYS

(71) Applicants: Jong Hun LEE, Siheung-si, Gyeonggi-do (KR); Sang Woo GO, Seongnam-si, Gyeonggi-do (KR)

(72) Inventors: Jong Hun LEE, Siheung-si, Gyeonggi-do (KR); Sang Woo GO, Seongnam-si, Gyeonggi-do (KR)

(21) Appl. No.: 16/462,262

(22) PCT Filed: Dec. 5, 2018
(86) PCT No.: PCT/KR2018/015312

§ 371 Date: May 20, 2019

(30) Foreign Application Priority Data
Feb. 26, 2018 (KR) 10-2018-0023057

(51) Int. Cl. F16L 3/23; H02G 3/04; H02G 3/06; F16B 5/06; F16L 3/02; F16L 3/10; F16L 15/00; B21D 28/26

(52) U.S. Cl. CPC F16L 3/23; H02G 3/0456; H02G 3/0608; B21D 28/26; F16L 3/02; F16L 3/1066; F16L 15/00; F16B 5/0621

(57) ABSTRACT

An object of the present invention is to provide an assembly of cable trays capable of reducing a manufacturing cost by allowing a load to be reinforced and maintained simply by an L-shaped pin assembly structure when coupling cable trays with a connecting member. The assembly of cable trays includes a cable tray, a connecting member, and a fixing member. Meanwhile, the connecting member is configured to allow: a pair of protruding insertion pieces to be integrally formed at the upper and lower portions, respectively, in the middle thereof; the fixing member to be coupled with a slot formed by the protrusion of the protruding insertion piece; and a clip portion to be formed in an outer side direction of each of the protruding insertion pieces so as to be supported by the through hole of the cable tray.

### TECHNICAL FIELD

The present invention relates to an assembly of cable trays and, more particularly, to an assembly of cable trays capable of reducing a manufacturing cost by allowing a load to be reinforced and maintained simply by a L-shaped pin assembly structure without using bolts for a vertical load and a horizontal load when coupling cable trays with a connecting member.

### BACKGROUND ART

Generally, big and small diameter cables are arranged along a ceiling and a floor or a wall for supply of power or fluid to a factory, a ship, and an offshore structure, and the cables arranged in this way are supported and fixed by using cable trays to avoid spoiling the aesthetics or inconveniencing passengers.

A conventional cable tray for supporting and fixing various cables as described above is configured largely to include: a pair of side frames positioned on left and right sides, respectively, with a predetermined length; and hangers (rod-shaped, plate-shaped) each coupled to the side frames at regular intervals between the side frames.

In addition, since the cable tray has the predetermined length in the longitudinal direction, a plurality of cable trays is connected using connecting members, thereby being allowed to be arranged along the ceiling or wall of a building.

An example of such a cable tray can be found in the “ASSEMBLY OF CABLE TRAY” of the Korea Patent No. 10-1266615.

The assembly of cable trays may include a resilient insertion piece formed in a connecting member for connecting the side frames arranged in succession in the longitudinal direction, and a fixing member coupled to the slot formed by protrusion of the resilient insertion piece, whereby adhesiveness of the connecting member for connecting the cable trays is improved, and the clearance of the fixing member for fixing the cable trays and the connecting member can be minimized.

However, in the conventional assembly of cable trays, a plurality of fixing members (four pieces) is required to be fixed to the connecting members for connecting the cable trays, which causes a manufacturing cost to be increased. Meanwhile, when the number of the fixing members is reduced, a load with respect to the vertical load and the horizontal load cannot be mitigated.

### RELATED ART DOCUMENT

(Patent Document 1) Korean Patent No. 10-1266615, (Registration Date: May 15, 2013)

### DISCLOSURE

### Technical Problem

Accordingly, the present invention is to solve the problems of the conventional art described above, and it is an object of the present invention to provide an assembly of cable trays capable of reducing a manufacturing cost by allowing a load to be reinforced and maintained simply by a L-shaped pin assembly structure without using bolts for a vertical load and a horizontal load when coupling cable trays with a connecting member.

In addition, the assembly of the cable trays according to the present invention is to provide the assembly of the cable trays, which is configured not only to strengthen the strength of side frames but also to allow the side frames to be easily coupled with a rung.

Further, the assembly of the cable trays according to the present invention is configured to provide a connection block for reinforcing against the widening of a gap between the side frames and the rung, thereby allowing the connection block to strengthen the strength of the assembly while assembling the assembly in a simple manner and preventing the cable from sagging during routing thereof.

### Technical Solution

In order to achieve the above object, according to one aspect of the present invention, there is provided an assembly of cable trays, the assembly including: a cable tray including a pair of side frames spaced apart from each other at a predetermined distance at left and right sides, respectively, the pair of side frames each having a plurality of through holes formed at opposite ends in the longitudinal direction thereof; a connecting member interconnecting the side frames in order to arrange the cable trays in succession in the longitudinal direction; and a fixing member fixing the cable trays and the connecting member after the connecting member is allowed to be brought into close contact with the inner side of the cable trays, wherein the connecting member is configured: to form a pair of protruding insertion pieces integrally at the upper and lower portions, respectively, in the middle thereof; to allow the fixing member to be coupled with a slot formed by a protrusion of the protruding insertion piece; and to allow a clip portion to be formed in an outer side direction of each of the protruding insertion pieces, thereby being supported by the through hole of the cable tray.

In addition, the assembly may be configured to couple rungs with the side frames at regular distances, wherein, by allowing a holding portion to be formed in a horizontal direction in each of the side frames, the rungs are coupled to be brought into close contact with a side below the holding portion.

In addition, the fixing member may be configured to be a semicircle.

In addition, the connecting members installed at the left and right sides, respectively, and spaced apart from each other at a predetermined distance may be connected by a connecting block, wherein opposite ends in a longitudinal direction of the connecting block are allowed to be fixed to slots each formed in the horizontal direction at a lower portion in the middle of each of the connecting members, correspondingly.

In addition, the protruding insertion piece may be configured to have one end thereof integrally formed at a main body of the connecting member and the other end thereof separated to form the free end.

In addition, the side frames may be coupled with rungs at regular distances, each of the side frames includes a protruding hook protruding inwardly thereon to support the top end of the rung, the rung has at least one latch bent downward at each of opposite ends in a longitudinal direction thereof, and the side frame and the rung are connected by a fixing means.

In addition, the protruding hook may be configured to be in contact with the top surface of the rung over a part or all of a rung width.

In addition, the protruding hook may be configured to be at least one piece.

In addition, the protruding hook may be configured to be formed by a press process.

In addition, protruding rims may be formed on the end portions of the top surface of opposite ends in the longitudinal direction of the rung in a process of being subjected to a cutting process of the rung and are in contact with a portion of the protruding hook.

In addition, a depression groove may be formed in a central portion of the rung width at each of opposite ends in the longitudinal direction of the rung, the depression groove is formed long in the longitudinal direction over the latch and the top portion of the rung, and a whole length of the depression groove does not exceed twice the height of the latch.

In addition, the latch may include a clip seating groove being installed with a bolt hole, with a perimeter of the bolt hole being protruded and formed integrally with the latch, and further having screw threads.

In addition, the assembly may be configured to have a separation distance between the side frame and the latch when the side frame and the rung are connected by the fixing means.

In addition, the separation distance between the side frame and the latch may be, with the lower end of the latch being as a reference, ½ to no more than 5 times the thickness of the rungs in a state before the fixing means is connected.

### Advantageous Effects

As a concept to accomplish the present invention, the assembly of the cable trays according to the present invention is configured to allow a pair of protruding insertion parts along with a pair of clip portions to be formed at the upper and lower portions, respectively, in the middle of a connecting member interconnecting adjacent side frames to arrange the cable trays in succession in the longitudinal direction. Thus, the assembly of the cable trays is capable of reducing manufacturing cost by allowing a load to be reinforced and maintained simply by an L-shaped pin assembly structure without using bolts for a vertical load and a horizontal load when coupling cable trays with a connecting member.

Further, it is possible to prevent a gap in the assembly of the cable trays from widening, thereby preventing the cable from sagging, reinforcing the load strength, and coupling the fixing member readily.

In addition, the assembly of the cable trays according to the present invention is configured to have the holding portion formed in the horizontal direction on each of the side frames thereof, thereby allowing the rung to be brought into close contact with the side under the holding portion. Accordingly, the assembly of the cable trays is configured to strengthen the strength of the side frames as well as to allow the side frames to be readily coupled with the rung.

### DESCRIPTION OF DRAWINGS

FIG. 1 is a perspective view illustrating an overall structure of an assembly of cable trays according to the present invention;

FIG. 2 is an exploded perspective view of an essential part of an assembly of cable trays according to the present invention;

FIG. 3 is a side cross-sectional view of an assembly of cable trays according to the present invention;

FIG. 4 is a front view illustrating only a connecting member in an assembly of cable trays according to the present invention;

FIG. 5 is a sectional view taken along line A-A in FIG. 4;

FIG. 6 is a sectional view taken along line B-B in FIG. 4;

FIG. 7 is a sectional view of another embodiment taken along line B-B in FIG. 4;

FIG. 8 is a perspective view illustrating another embodiment in which a side frame and a rung according to the present invention are coupled;

FIG. 9 is a sectional view illustrating another embodiment in which a side frame and a rung according to the present invention are coupled; and

FIG. 10 is a side view of a rung of another embodiment according to the present invention.

### MODE FOR INVENTION

Hereinafter, composition and an operation of embodiments of the present invention will be described with reference to the accompanying drawings.

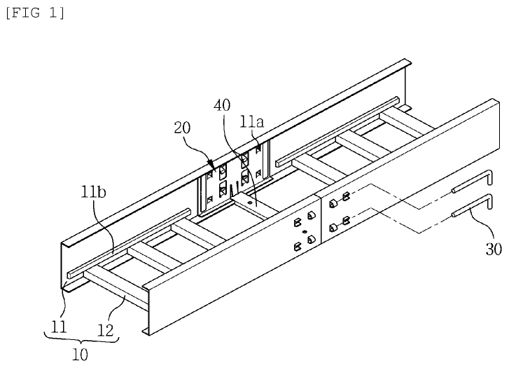

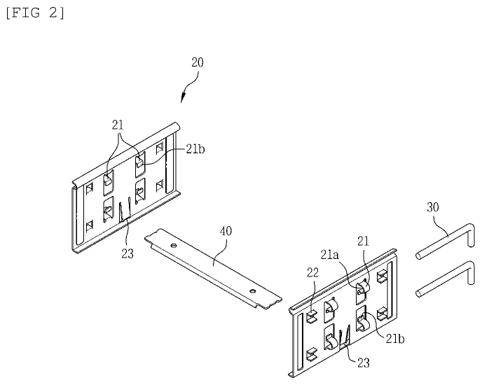

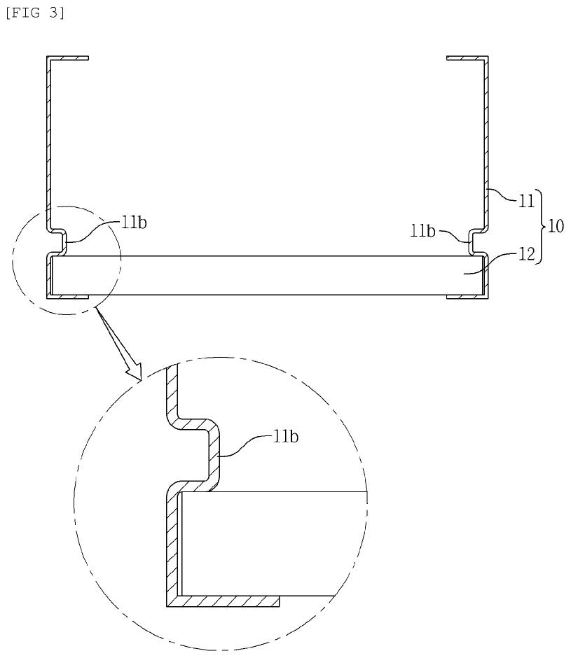

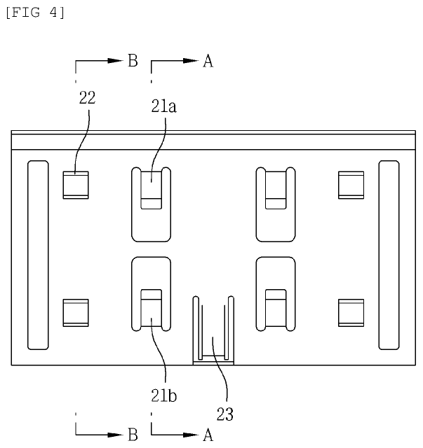

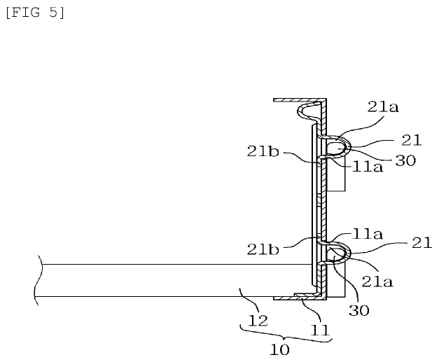

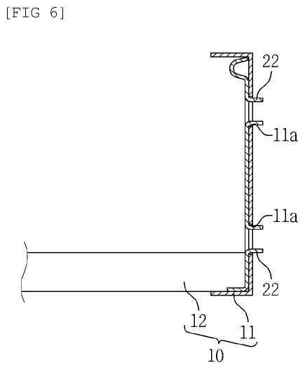

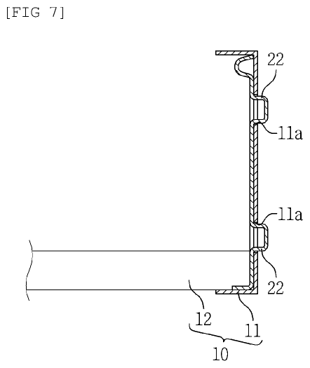

FIG. 1 is a perspective view illustrating an overall structure of an assembly of cable trays according to the present invention, FIG. 2 is an exploded perspective view of an essential part of an assembly of cable trays according to the present invention, FIG. 3 is a side cross-sectional view of an assembly of cable trays according to the present invention, FIG. 4 is a front view illustrating only a connecting member in an assembly of cable trays according to the present invention, FIG. 5 is a sectional view taken along line A-A in FIG. 4, FIG. 6 is a sectional view taken along line B-B in FIG. 4, FIG. 7 is a sectional view of another embodiment taken along line B-B in FIG. 4.

With reference to FIGS. 1 to 7, an assembly of cable trays 100 according to the present invention includes a cable tray 10, a connecting member 20, and a fixing member 30.

The cable tray 10 includes a pair of side frames 11 spaced apart from each other at a predetermined distance at left and right sides, respectively, the pair of side frames 11 each having a plurality of through holes 11a formed at opposite ends in the longitudinal direction thereof.

Here, the side frames 11 may be connected by a plurality of rungs 12 or plate structures connecting the side frames 11. In the present invention, a state in which the rungs 12 are coupled with the side frames 11 will be described as an example.

Meanwhile, the assembly is configured to couple rungs with the side frames at regular distances, wherein, by allowing a holding portion to be formed in a horizontal direction in each of the side frames, and then by coupling the rungs to be brought into close contact with a side below the holding portion, strength of the assembly is reinforced even if a thickness of the side frames is thin.

In addition, the holding portion 11b may be continuous or may have sections of a predetermined length, the sections being spaced apart from each other at regular distances.

The connecting member 20 interconnects the adjacent side frames 11 in order to arrange the cable trays 10 in succession in the longitudinal direction.

In addition, the connecting member 20 is configured: to form a pair of protruding insertion pieces 21 integrally at the upper and lower portions, respectively, in the middle thereof; to allow the fixing member 30 to be coupled with a slot 21a formed by a protrusion of the protruding insertion piece 21; and to allow a clip portion 22 to be formed in an outer side direction of each of the protruding insertion pieces 21, thereby being supported by the through hole 11a of the cable tray 10.

In addition, the protruding insertion piece 21 is configured to have one end thereof integrally formed at a main body of the connecting member 20 and the other end thereof separated to form the free end 21b, thereby allowing elasticity to be improved when the fixing member 30 is coupled therewith.

Further, the clip portion 22 may be passed through as shown in FIG. 6, or the front side thereof may be closed as shown in FIG. 7.

The fixing member 30 is configured to fix the cable trays 10 and the connecting member 20 after the connecting member 20 is allowed to be brought into close contact with the inner side of the cable trays 10.

In addition, the fixing member 30 is configured to be a semicircle, thereby entering smoothly when inserted into the slot 21a and playing a role to reduce a gap and to increase the strength by being rotated 90 degrees and fixed to the protrusion insertion piece 21.

In addition, the fixing member 30 may be modified in various shapes such as a semi-circle, a circle, a rectangle having a stepped shape formed therein, or the like.

In addition, the connecting members 20 installed at the left and right sides, respectively, and spaced apart from each other at a predetermined distance are connected by a connecting block 40, wherein opposite ends in the longitudinal direction of the connecting block 40 are allowed to be fixed to the coupling grooves 23, each formed in the horizontal direction at a lower portion in the middle of each of the connecting members 20, correspondingly, thereby allowing the clearance and the coupling force of the connecting members 20 to be improved.

Further, a distance between the rungs 12 may be widened due to the portion where the connecting member 20 is coupled, thereby causing the load strength of the assembly of the cable trays to be decreased. However, it is possible to reinforce the load strength by the connecting block 40, and even when the rung is composed of the plate, it is also possible to protect a gap between the plates or to prevent a bird caging from occurring, thereby allowing the cable to be protected.

In addition, it is possible to shorten the distance between the rung 12 of a first tray and the rung 12 of a second tray by assembling the connection block 40 concisely, thereby preventing the cable from sagging, reinforcing the load strength, and easily coupling the fixing member 30.

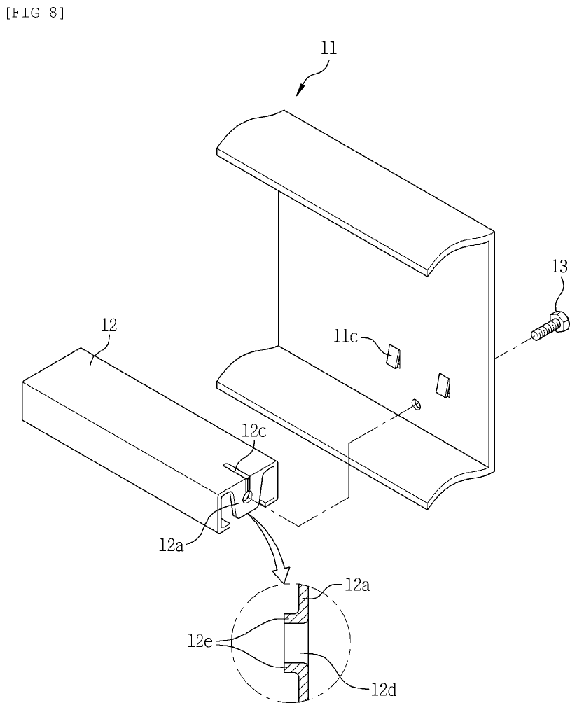

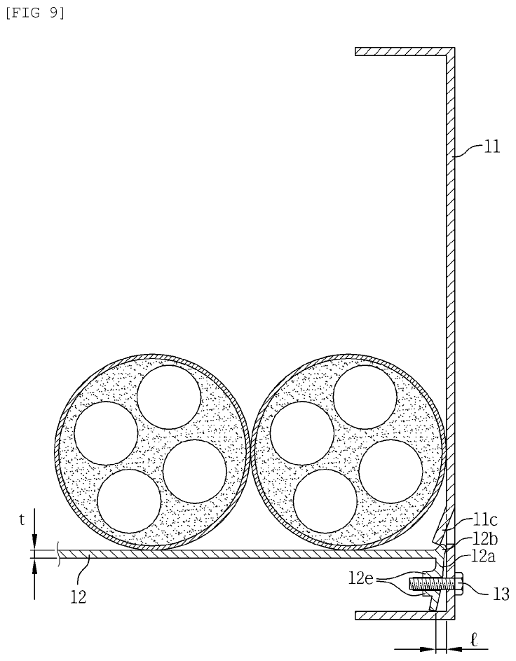

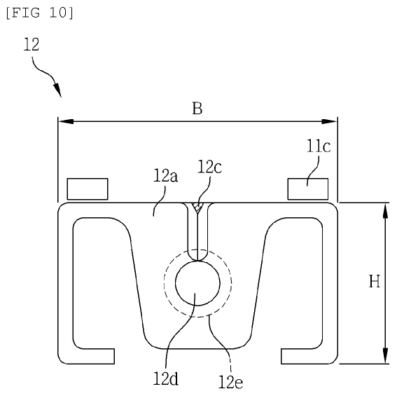

Meanwhile, FIG. 8 is a perspective view illustrating another embodiment in which a side frame and a rung according to the present invention are coupled; FIG. 9 is a sectional view illustrating another embodiment in which a side frame and a rung according to the present invention are coupled; and FIG. 10 is a side view of a rung of another embodiment according to the present invention.

With reference to FIGS. 8 to 10, there are provided a pair of the side frames 11 and a plurality of the rungs 12 repeatedly installed at regular distances between the pair of side frames 11, wherein side frames 11 each include a protruding hook 11c protruding inwardly by an extrusion or cutting process to support an end portion of the top surface of the rung 12.

Meanwhile, the rung 12 has latches 12a bent downward at opposite ends in the longitudinal direction, and the side frames 11 and the rungs 12 are connected and fixed using a permanent or disassemblable fixing means 13, wherein the latch 12a is most preferably composed of one latch, and, when a high structural strength is required, the latch 12a may be composed of a plurality of latches.

In addition, the protruding hook 11c is configured to be in contact with the top surface of the rung 12 over a part or all of the rung width B.

Accordingly, the protruding hook 11c may be composed of one piece or a plurality of disconnected pieces, and a structure may be added such that the protruding hooks 11c are configured to be in contact with outer sides of the opposite side surfaces including the end portion of the top surface of the rung 12. In this case, the protruding hook 11c molded by the extrusion or bending method by the press process may prevent the production process from being added, thereby being effective.

In addition, rims 12b protruding upwards are formed on the end portion of the top surfaces of opposite ends in the longitudinal direction of the rungs 12 by a phenomenon that the plate material is pushed by a press in a process of being subjected to a vertical cutting process of the rungs 12 using a press. Here, the rims 12b are preferable to be in contact with a portion of the protruding hook 11c.

In addition, a depression (a) groove 12c is formed in the central portion of the rung width B at each of opposite ends in the longitudinal direction of the rung 12 for the purpose of reinforcing the strength of the rung using a thin plate.

Meanwhile, the groove 12c is formed long in the longitudinal direction over the latch 12a and the top portion of the rung 12, and the whole length of the groove 12c is preferable not to exceed twice the height H of the latch.

In addition, the fixing means 13 for the side frame 11 and the rung 12 may use any one of a bolt and a rivet, and is preferable to allow the latch to include a clip seating groove 12e being installed with a bolt hole, with a perimeter of the bolt hole 12d being protruded and formed integrally with the latch, and further having screw threads.

In addition, in order to prevent the bolt from being loosened due to the small number of screw threads of the bolt hole 12d of the thin rung 12 (to have functions of giving an effect to bring into close contact with each other when the side frame 11 and the rung 12 are fixed by the fixing means 13 and of maintaining elasticity thereof after the side frame 11 and the rung 12 are connected and fixed), when the side frame 11 and the rung 12 are connected by the fixing means 13, it is preferable to have a separation distance 1 between the side frame 11 and the latch 12a. More preferably, with the lower end of the latch 12 being as a reference, the separation distance 1 between the side frame 11 and the latch 12a should be maintained in a range of ½ to no more than 5 times the thickness t of the rung plate in a state before the fixing means is connected.

The assembly of the cable trays 100 according to the present invention as described above is configured to connect the side frames 11, adjacent to each other, of the cable trays 10 in order to interconnect the cable trays 10 in succession in the longitudinal direction, whereby the protruding insertion piece 21 and the clip portion 22 of the connecting member 20 are inserted into the plurality of through holes 11a formed in the side frames 11.

In addition, when the fixing member 30 is coupled to the slot 21a formed by the protrusion of the protruding insertion piece 21, the side frames 11 and the connecting member 20 are integrated with each other, thereby allowing the cable tray 10 to be arranged in succession in the longitudinal direction.

At this time, the clip portion 22 formed on the outer side direction of the protruding insertion piece 21 is supported by the through hole 11a of the side frame 11, thereby allowing the vertical load and the horizontal load to be reinforced and maintained with a simple structure.

In addition, when the fixing member 30 is coupled to the protruding insertion piece 21, the elasticity of the protruding insertion piece 21 may be improved by the free end 21b formed on the other end of the protruding insertion piece 21.

In addition, the rungs 12 are coupled to the side under the holding portion 11b formed in the horizontal direction on the side frame 11, thereby reinforcing the strength of the side frame 11.

In addition, as another embodiment of the holding portion 11b, the protruding hook 11c of the side frame 11 is supported on the end portion of the top surface of the rung 12, and the rung 12 and the side frame 11 may be fixed by the fixing 13.

In addition, each of the connecting members 20 installed at the left and right sides and spaced apart from each other at a predetermined distance is connected to the connecting block 40, thereby fixing each of the opposite ends in the longitudinal direction of the connecting block 40 to the coupling grooves 23 formed at a lower portion in the middle of each of the connecting members 20, correspondingly.

While the invention has been described with reference to an embodiment thereof, it will be understood by those skilled in the art that various changes and modifications may be made therein without departing from the spirit and scope of the invention as defined by the appended claims.

1. An assembly of cable trays, the assembly comprising:
a cable tray including a pair of side frames spaced apart from each other at a predetermined distance at left and right sides, respectively, the pair of side frames each having a plurality of through holes formed at opposite ends in the longitudinal direction thereof;
a connecting member interconnecting the side frames in order to arrange the cable trays in succession in the longitudinal direction; and
a fixing member fixing the cable trays and the connecting member after the connecting member is allowed to be brought into close contact with the inner side of the cable trays,
wherein the connecting member is configured: to form a pair of protruding insertion pieces integrally at the upper and lower portions, respectively, in the middle thereof; to allow the fixing member to be coupled with a slot formed by a protrusion of the protruding insertion piece; and to allow a clip portion to be formed in an outer side direction of each of the protruding insertion pieces, thereby being supported by the through hole of the cable tray.

2. The assembly of claim 1, wherein the assembly is configured to couple rungs with the side frames at regular distances, wherein, by allowing a holding portion to be formed in a horizontal direction in each of the side frames, the rungs are coupled to be brought into close contact with a side below the holding portion.

3. The assembly of claim 1, wherein the fixing member is configured to be a semicircle.

4. The assembly of claim 1, wherein the connecting members installed at the left and right sides, respectively, and spaced apart from each other at a predetermined distance are connected by a connecting block, wherein opposite ends in a longitudinal direction of the connecting block are allowed to be fixed to slots each formed in the horizontal direction at a lower portion in the middle of each of the connecting members, correspondingly.

5. The assembly of claim 1, wherein the protruding insertion piece is configured to have one end thereof integrally formed at a main body of the connecting member and the other end thereof separated to form the free end.

6. The assembly of claim 1, wherein the side frames are coupled with rungs at regular distances, each of the side frames includes a protruding hook protruding inwardly thereon to support the top end of the rung, the rung has at least one latch bent downward at each of opposite ends in a longitudinal direction thereof, and the side frame and the rung are connected by a fixing means.

7. The assembly of claim 6, wherein the protruding hook is configured to be in contact with the top surface of the rung over a part or all of a rung width.

8. The assembly of claim 6, wherein the protruding hook is configured to be at least one piece.

9. The assembly of claim 6, wherein the protruding hook is configured to be formed by a press process.

10. The assembly of claim 6, wherein protruding rims are formed on the end portions of the top surface of opposite ends in the longitudinal direction of the rung in a process of being subjected to a cutting process of the rung and are in contact with a portion of the protruding hook.

11. The assembly of claim 6, wherein
a depression groove is formed in a central portion of the rung width at each of opposite ends in the longitudinal direction of the rung,
the depression groove is formed long in the longitudinal direction over the latch and the top portion of the rung, and
a whole length of the depression groove does not exceed twice the height of the latch.

12. The assembly of claim 6, wherein the latch includes a clip seating groove being installed with a bolt hole, with a perimeter of the bolt hole being protruded and formed integrally with the latch, and further having screw threads.

13. The assembly of claim 6, wherein the assembly is configured to have a separation distance between the side frame and the latch when the side frame and the rung are connected by the fixing means.

14. The assembly of claim 13, wherein the separation distance between the side frame and the latch is, with the lower end of the latch being as a reference, ½ to no more than 5 times the thickness of the rungs in a state before the fixing means is connected.
